(19) United States
(12) Patent Application Publication
(10) Pub. No.: US 2025/0111272 A1
(43) Pub. Date: Apr. 3, 2025

(54) ENHANCED MACHINE LEARNING TECHNIQUES USING DIFFERENTIAL PRIVACY AND SELECTIVE DATA AGGREGATION

(71) Applicant: Google LLC, Mountain View, CA (US)

(72) Inventors: Wei Huang, Mountain View, CA (US); Zhenyu Liu, Mountain View, CA (US); Liang Wang, Mountain View, CA (US); Kumar Rishabh, 1600 Amphitheatre Parkway, CA (US)

(73) Assignee: Google LLC, Mountain View, CA (US)

(21) Appl. No.: 18/574,668

(22) PCT Filed: Apr. 25, 2023
(86) PCT No.: PCT/US2023/019788

§ 371 Date: Dec. 27, 2023

(51) Int. Cl. G06N 20/00

(52) U.S. Cl. CPC G06N 20/00

(57) ABSTRACT

Methods, systems, and apparatus, including computer programs encoded on a computer storage medium, for distributing digital contents to client devices are described. The system obtains, for each user in a set of users, user attribute data and, for a subset of the users, consent data for controlling usage of the user attribute data. The system partitions, based at least on the consent data for the subset of users, the set of users into a first group of users and a second group of users. The system generates a respective training dataset based on the data for each group of user, and uses the datasets to train a machine learning model configured to predict information about one or more users. In particular, the system applies differential privacy to the second training dataset without applying differential privacy to the first training dataset during training.

### TECHNICAL FIELD

This specification is generally related to machine learning.

### BACKGROUND

A machine learning model is a computational model that learns patterns and relationships in data, and then uses that knowledge to make predictions or decisions on new data. The model parameters of a machine learning model can be learned based on training data.

### SUMMARY

This specification describes methods, computer systems, and apparatus, including computer programs encoded on computer storage media, for training a machine learning model that outputs predictions of user information in ways that protect the privacy of the users and their data.

In one innovative aspect, this specification describes a method for distributing digital components to client devices. The method can be implemented by a system including one or more computers. The system obtains, for each user in a set of users, user data including user attribute data and, for a subset of the users, consent data for controlling usage of the user attribute data for the users in the subset of the users. The system partitions, based at least on the consent data for the subset of users, the set of users into a first group of users and a second group of users. The system generates a first training dataset based on the user data for the first group of users, and generates a second training dataset based on the user data for the second group of users. The system trains, using the first training dataset and the second training dataset, a machine learning model configured to predict information about one or more users, the training including applying differential privacy to the second training dataset without applying differential privacy to the first training dataset. The system distributes, digital components to client devices using the machine learning model. Other implementations of this aspect include corresponding apparatus, systems, and computer programs, configured to perform the aspects of the methods, encoded on computer storage devices.

These and other implementations can each optionally include one or more of the following features. In some implementations, the machine learning model is configured to process an input including data specifying one or more contextual signals included in a digital component request from a client device and to generate prediction data about the user of the client device based on the input.

In some implementations, the machine learning model is configured to process an input including data characterizing a digital component to generate prediction data about an audience segment for the digital component based on the input.

In some implementations, the user data includes first user attribute data generated on a first content platform and first consent data controlling usage of the first user attribute data on one or more second content platforms.

In some implementations, to train the machine learning model on the second training dataset with differential-privacy processing, the system applies differentially private stochastic gradient descent (DP-SGD) to update model parameters of the machine learning model using the second training dataset.

In some implementations, the user data for each user includes location data indicating a geographic region of the user, and partitioning the users into the first group and the second group is further based on the geographic region of the user.

For example, to partition the users into the first group and the second group, the system can determine, based on the location data, that a user is located in a first geographic region. In response to determining that the user is located in the first geographic region, the system assigns the user to the first group if consent data is available for the user and the consent data for the user indicates the user permitting the one or more uses of the set of user data, and assigns the user to the second group if consent data is unavailable for the user or the consent data for the user does not indicate the user permitting the one or more uses of the set of user data.

In another example, to partition the users into the first group and the second group, the system can determine, based on the location data, that a user is located in a second geographic region. In response to determining that the user is located in the second geographic region, the system assigns the user to the first group.

In another example, to partition the users into the first group and the second group, the system determines, based on the location data, that a user is located in a third geographic region. In response to determining that the user is located in the third geographic region, the system assign the user to the second group.

In another example, to partition the users into the first group and the second group, the system determines, based on the location data, that a user is located in a fourth geographic region. In response to determining that the user is located in the fourth geographic region, the system excludes the user from both the first and the second group.

In some implementations, the trained machine learning model is configured to output, based on the contextual signals in the digital component request, predicted data about the user of the digital component request.

In some implementations, to generate the first training dataset, for each of a set of aggregation keys, the system generates an aggregated data profile by aggregating the user data of a respective subset of the first group of users having electronic resource views that match the aggregation key. To generate the second training dataset, for each of the set of aggregation keys, the system generates an aggregated data profile by aggregating the user data of a respective subset of the second group of users having electronic resource views that match the aggregation key.

For example, to generate the second training dataset, for each of the set of aggregation keys, before aggregating the user data of the respective subset of the second group of users, the system can further apply differential privacy to the user data of the respective subset of the second group of users. To train the machine learning model, the system can add the aggregated data profiles as training labels of the machine learning model.

In some implementations, the trained machine learning model is configured to output, based on the data characterizing the digital component, predicted data about one or more audience segments for the digital component.

In some implementations, the respective set of user data includes user profile data for a user registered on a digital service platform.

Particular embodiments of the subject matter described in this specification can be implemented so as to realize one or more of the following advantages. The performance of a machine learning model is heavily influenced by the training data used to train the model. The quality, quantity, and diversity of the training data can significantly impact the accuracy and generalizability of the model. For example, with larger amounts of data, the model can learn more complex relationships and generalize better to new data. However, when the training data include user information, there may be privacy concerns associated with the use of such data. For example, in some cases, even if personal information is removed from the training data, it may still be theoretically possible to re-identify individuals using other sources of data in the training data and compromise their privacy. Differential privacy is a privacy-enhancing technique that aims to protect sensitive information in datasets while still allowing for useful insights to be extracted from the datasets. Applying differential privacy in training data for training a machine learning model can provide privacy protection for individuals in the training data by making it more difficult for attackers to re-identify specific individuals in the data.

A content distribution system can leverage user data of a set of users, e.g., users that have accessed a particular electronic resource (e.g., website) or a digital component (e.g., a video/audio clip, image, or text) to guide the selection and distribution of content to other users, e.g., to distribute content that best fit the interests or needs of the users. In particular, machine learning models can be trained to output predictions about unknown users of electronic resources, which can then be used to select and/or customize content (e.g., digital components) for the users. For example, the machine learning techniques allow for the selection and distribution of content that is relevant to users based on a limited set of signals, such as a resource locator for the electronic resource with which the content is presented, a type of device at which the content will be presented, coarse location information (e.g., country) for the device, and/or other user characteristics, by leveraging rich data about a set of users for which such data is available.

By using the trained machine learning models to select relevant content for presentation at the user devices, the online experience for the users can be improved, and the effectiveness of content presentation of the content providers can be enhanced. Further, the efficiency of transmitting content to client devices is improved as content that is not relevant to a particular user need not be transmitted. In addition, third-party cookies are not required thereby avoiding the storage of third-party cookies, improving memory usage, and reducing the amount of bandwidth that would otherwise be consumed by transmitting the cookies.

The quality and quantity of training data (e.g., the relevant user data) are important factors impacting the performance of a machine learning model. On the other hand, the privacy and security of the user data need to be protected. In particular, it is important to obtain user consent before collecting and/or using user data and to ensure that such data is only collected and used in accordance with the users' consent. Since different users can have different settings and preferences on if and when a system may collect particular user information and how such information is used, in some cases, online platforms and digital component distribution systems can allow users to make elections on the settings and preferences for user data collection and use.

This specification provides techniques for leveraging the use of relevant user data for training a machine learning model while respecting the users' settings and preferences on how the user data is used. In particular, the described techniques can selectively apply data privacy strategies and associated techniques based on user consent data in aggregating and using training data for the machine learning model which is configured to predict information of users of electronic resources, which can then be used to select and/or customize content for the users. As a result, while ensuring the protection of user data privacy according to user consent, the described techniques can improve the performance (e.g., prediction accuracy) of the machine learning model by improving the quantity and/or quality of the training data, by improving how the training data is used. Consequently, a content platform or a digital component distribution system can use a machine learning model to more efficiently and more effectively select and customize digital content for display to the users.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a digital component distribution system distributes digital components to client devices.

FIG. 2 is a swim lane diagram of an example process for distributing digital components for display at client devices.

FIG. 3 is a flow diagram of an example process for distributing digital components for display at client devices.

FIG. 4 is a block diagram of an example computer system.

Like reference numbers and designations in the various drawings indicate like elements.

### DETAILED DESCRIPTION

In general, this specification describes systems and techniques for providing digital content, e.g., digital components, to client devices in ways that protect user privacy. A model training system, e.g., implemented by a computing system, can be configured to generate training datasets using user attribute data and based on user consent data. The model training system uses the generated training datasets to train a machine learning model configured to predict information about one or more users. A digital component distribution system or a content platform can use the prediction outputted by the trained machine learning model to select digital content for being distributed to user devices.

Further to the descriptions throughout this document, a user may be provided with controls (e.g., user interface elements with which a user can interact) allowing the user to make an election as to both if and when systems, programs, or features described herein may enable the collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

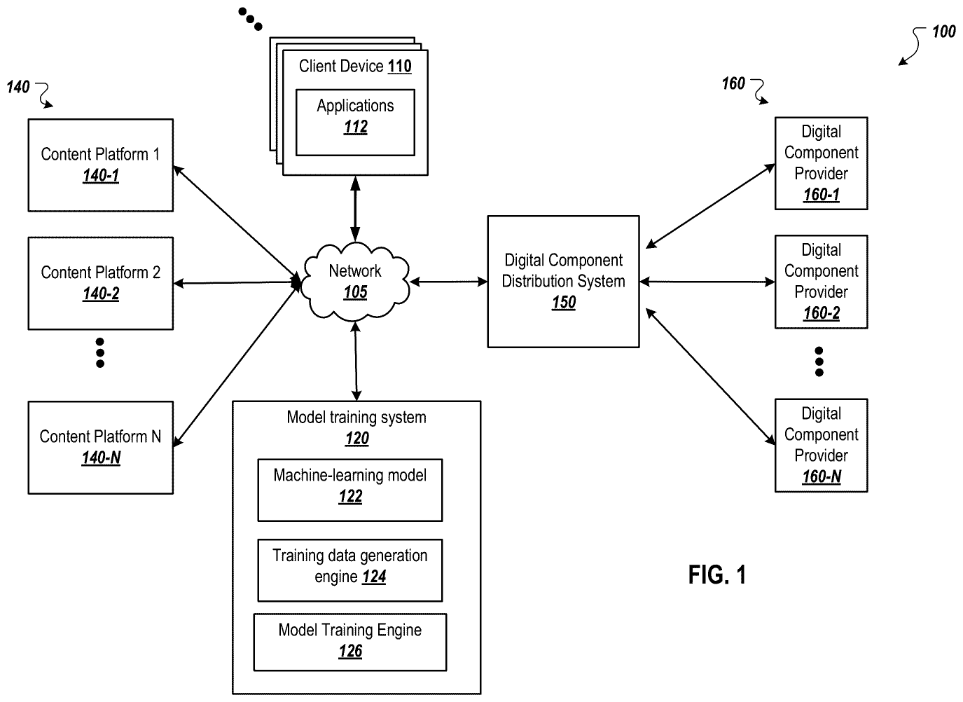

FIG. 1 is a block diagram of an example environment 100 in which a digital component distribution system 150 distributes digital components to client devices 110. The environment 100 includes a data communication network 105, such as a local area network (LAN), a wide area network (WAN), the Internet, a mobile network, or a combination thereof. The data communication network 105 connects client devices 110 to the digital component distribution system 150. The network 105 can also connect the digital component distribution system 150 digital component providers 160, e.g., 160-1, 160-2, and 160-N. The data communication network 105 connects client devices 110 with one or more content platforms 140, e.g., 140-1, 140-2, and 140-N.

Each of the content platforms 140 can be implemented by one or more computers in one or more locations, and is configured to distribute digital content (e.g., electronic resources and/or digital components) to the client devices 110 via the network 105. Examples of content platforms include social media sites, blogging platforms, search engine platforms, online shopping platforms, virtual assistant platforms, generative AI platforms, video platforms, music platforms, podcast platforms, gaming platforms, and so on. The content platform 140 can allow a user to create a user account associated with a user profile and a user ID. The user profile can include user attribute information that the user provided during the creation or update of the user account. In some implementations, multiple of the content platforms 160 can be managed by the same entity and the same user ID can be shared across the multiple content platforms.

The content platform 140 can provide users with controls (e.g., user interface elements with which a user can interact) allowing the user to make an election to enable or disable the collection of user information during the use of the content platform (e.g., a user's current location, a user's activities on the content platforms, a user's device information, etc.) The content platform 140 can further allow the user to control how the user information (including the information in the user profile and/or the information collected by content platform related to user activities on the content platform) can be used. The content platform 140 can generate user consent data based on the user settings for collecting and/or using the user data.

In some implementations, the content platform 140 allows the user to control the use of user data with fine granularity. For example, the user consent data can indicate whether the user allows a particular set of user information to be combined with data from other users for being used to derive insight on selecting content for a group of users. If the user allows the particular set of user information to be combined with data from other users, the user consent data can further indicate whether the user allows how the combined data can be used, for example, a level of privacy protection when combining and/or using the data, or whether the combined data can be used by a different content platform. For example, a user may specify that the user's data can or cannot be used by a different content platform to recommend content that the user may be interested in consuming (e.g., viewing and/or listening).

An electronic resource is also referred to herein as a resource for brevity. In this specification, resources can include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). A resource can be identified by a resource address, e.g., a Universal Resource Locator (URL) that is associated with the resource.

A client device 110 is an electronic device that is capable of communicating over the network 105. Example client devices 110 include personal computers, server computers, mobile communication devices, e.g., smart phones and/or tablet computers, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., a watch or a pair of glasses), a smart phone, a speaker device, a tablet device, or another hardware device. A client device can also include a digital media device, e.g., a streaming device that plugs into a television or other display to stream videos to the television, a gaming device, or a virtual reality system.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

A client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

As used throughout this specification, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 can generate a digital component request that requests a digital component for display in the digital component slot. In some implementations, the digital component slot and/or the resource can include code (e.g., scripts) that cause the application 112 to request a digital component from the digital component distribution system 150.

A digital component request can include contextual data, which is generally considered non-sensitive. The contextual data can describe the environment in which a selected digital component will be presented. The contextual data can include, for example, coarse location information indicating a general location of the client device 110 that sent the digital component request, a resource (e.g., website or native application) with which the selected digital component will be presented (e.g., by including a resource locator such as a URI or URL for the resource), a spoken language setting of the application 112 or client device 110, the number of digital component slots in which digital components will be presented with the resource, the types of digital component slots, and/or other appropriate contextual information.

The digital component distribution system 150 can identify, e.g., predict, user attributes of the user of the client device 110 from which a digital component request is received based on data (e.g., contextual data) included in the digital component request. In response to the digital component response, the digital component distribution system 150 can send attribute data specifying the user attributes identified from the digital component request to the client device 110.

The model training system 120 can be implemented by one or more computers in one or more locations, and configured to receive user data from the client devices 110 of a set of users and learn the model parameters of a machine learning model 122 based on the received user data.

The machine learning model 122 is configured to process an input to predict information about one or more users. For example, the machine learning model can be configured to process an input that includes data specifying one or more contextual signals included in a digital component request from a client device to generate prediction data about the user of the client device. In another example, the machine learning model is configured to process an input that includes data characterizing a digital component to generate prediction data about an audience segment (e.g., including users characterized by one or more common attributes or interests) for the digital component.

The model training system 120 includes a training data generation engine 124 configured to generate datasets for training the machine learning model 122. The model training system 120 further includes a model training engine 126 configured to train the machine learning model 122 based on the generated datasets.

To comply with user consent with regard to user data privacy protection, the training data generation engine 124 can generate different datasets for users with different user data privacy settings (e.g., different user consent settings), and use the generated datasets differently during training of the machine learning model 122. For example, based on user consent data, the training data generation engine 124 can generate a first training dataset for a first group of users having a first data privacy setting, and a second training dataset for a second group of users having a second data privacy setting.

The first data privacy setting can be different from the second data privacy setting in one or more ways. For example, the first group of users may have allowed their user data to be combined with data from other users with a certain privacy level, and allowed the combined data to be used for predicting insights for content distribution for a particular content platform (e.g., for the same content platform on which the user data is collected or for a different platform). The second group of users may have allowed their user data to be combined with data from other users, but required a different (e.g., higher) privacy level for how the data is combined and used.

To comply with the users' settings for data privacy levels, the training data generation engine 124 and/or the model training engine 126 can apply one or more data privacy techniques, e.g., k-anonymity techniques and/or differential privacy techniques when generating the training datasets.

In one particular example, when the second group of users require a higher level of privacy for their user data, the training data generation engine 124 can apply differential privacy techniques when aggregating the data from the second group of users. For example, to apply differential privacy, the training data generation engine 124 can add random noises to user attribute data before aggregating the user data from different users in the second group.

In another example, when the second group of users require a higher level of privacy for their user data, the model training engine 126 can apply differential privacy techniques when using the second training dataset to perform training of the machine learning model 122. For example, to apply the differential privacy process, the model training engine 126 can apply a differentially private stochastic gradient descent (DP-SGD) algorithm with a certain privacy tradeoff parameter (ε) to update model parameters of the machine learning model 122 using the second training dataset. A goal of DP-SGD is to provide strong guarantees of data privacy of individual training data points. That is, by applying the DP-SGD process when using the training dataset, the output of the training (e.g., the trained model) cannot be used to determine with high confidence whether any particular individual's data was used in the training process, and hence cannot infer any sensitive information about the individual. DP-SGD can be implemented by adding calibrated noise to the gradients computed on each mini-batch of training data. The amount of noise added is determined by the privacy tradeoff parameter (ε), which in turn determines a tradeoff between privacy and accuracy. In some implementations, the training system 120 can determine the privacy tradeoff parameter (ε) based on a privacy level selected by the users in the second group. In some other implementations, the privacy tradeoff parameter (ε) can be chosen based on a default value, e.g., ε=5, 10, 15, or another value.

In some implementations, based on the user consent data, the training data generation engine 124 can exclude user data from certain users (e.g., users that have not given consent of using their data) from being included in the training datasets.

In some implementations, training data generation engine 124 can generate training datasets based on other data in addition to the user consent data. For example, when the consent data is not available for a particular use (e.g., cross-platform use) of the user data, the system can use other information, such as user device types, user default language, and/or the geographic regions of the user location. In a particular example, statistical data may show that users from a certain geographic region are generally more concerned with data privacy protection than users in some other parts of the world. For a particular user in that geographic region, if the consent data does not include explicit permission for a certain use of the user data, the training data generation engine 124 can exclude the data of the user by default for the particular use, or apply differential privacy by default for the particular use.

After the machine learning model 122 has been trained, the model training system 120 can send data specifying the trained model 122 to the digital component distribution system 150 or the content platforms 140 to guide the digital component distribution system 150 or the content platforms 140 to distribute digital contents to client devices.

The digital component distribution system 150 can identify a set of digital components that are eligible to be presented to the client device 110 from among a corpus of digital components that are available from the content platform 150. For example, the digital component distribution system 150 can select one or more digital components from digital components stored in a digital component repository and/or a set of digital components received from digital component providers 160.

The digital component repository can store digital components received from the digital component providers and additional data (e.g., metadata) for each digital component in a database. The metadata for a digital component can include, for example, distribution criteria that define the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. The distribution criteria and the selection parameter can be characterized by one or more distribution parameters.

For example, the distribution parameters for a particular digital component can include distribution keywords that must be matched, e.g., by terms specified in the request, in order for the digital component to be eligible for display at the client device. In another example, the distribution criteria for a digital component can include location information indicating which geographic locations that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). The distribution parameters can also specify a selection parameter and/or budget for distributing the particular third-party content.

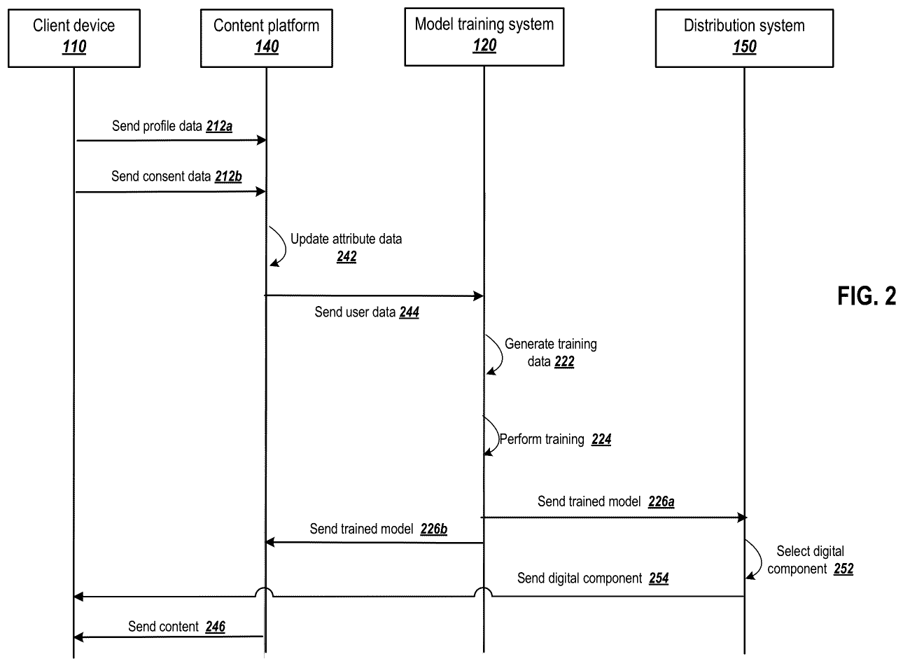

FIG. 2 is a swim lane flow diagram of an example process 200 for distributing digital components for display at client devices. Operations of the process 200 can be implemented, for example, by a client device 110, a model training system 120, and a digital component distribution system 150, one or more publishers 130, and one or more content platforms 140. Operations of the process 200 can also be implemented as instructions stored on computer-readable media, which may be non-transitory, and execution of the instructions by data processing apparatus can cause the data processing apparatus to perform the operations of the process 200.

At 212a, the client device 110 sends profile data to the content platform 140. At 212b, the client device 110 sends consent data to the content platform 140. The content platform 140 can receive user profile data and/or the consent data from the client device 110 when a user registers an account on the content platform 140, or when the user updates the account information.

The user profile data can include one or more of: the user's demographic information, the user's contact information, the user's login credentials, the user's social media profiles, the user's payment information, or the user's preferences including the user's language, timezone, interests, notification preferences, and/or other settings that can be customized according to their preferences. In general, the user profile data can include sensitive information (such as the user's name and other information that can uniquely identify the user) and non-sensitive information, such as attributes including timezone, language, or interests, that cannot be used to uniquely identify the user.

The user consent data includes data that specifies, for example, whether the user allows the collection of certain information during the use of the content platform (e.g., a user's current location, a user's activities on the content platforms, a user's device information, etc.), and the user's setting on how the user information can be used. For example, the user consent data can indicate whether the user allows a particular set of user information to be combined with data from other users and to be used to derive insight on selecting content for a group of users. If the user allows the particular set of user information to be combined with data from other users, the user consent data can further indicate whether the user allows how the combined data can be used, for example, the level of privacy protection when combining the data, and/or whether the combined data can be used for a different content platform.

At 242, the content platform 242 can update the user's attribute data based on the user's activities on the content platform. The attribute data can include the non-sensitive information in the user profile data, and additional data associated with user activities on the content platform 242, including, for example, the content the user has viewed, the searches the user has made, and the interactions they have had with other users. In general, the content platform 242 can update the attribute data ta according to the user consent for data collection. For example, the content platform 242 can record activity data that the user has given permission for being collected, and does not record activity data that the user has instructed not to be collected.

In some implementations, the content platform can update the attribute data based on the contextual data in the user's requests for digital components. For example, the contextual data can identify the electronic resource (e.g., the website) with which the selected digital component will be presented. In a particular example, the contextual data can include the URL or URI of the electronic resource. The contextual data can include, for example, coarse location information indicating a general location of the client device 110, a spoken language setting of the client device 110, the number of digital component slots in which digital components will be presented with the resource, the types of digital component slots, and/or other appropriate contextual information.

At 244, the content platform 140 sends the user data 244 to the model training system 120. The user data 244 includes at least a portion of the user attribute data and can further include the consent data. In some implementations, content platform 140 only sends a portion of the attribute data that only includes non-sensitive information.

At 222, the model training system 120 generates training data from the user data received from a set of client devices 110. That is, the processes described above, including 212a, 212b, 242, and 244, can be repeatedly performed for multiple client devices 110, and the model training system 120 obtains the user data from each of the multiple client devices 110.

To comply with user consent with regard to user data privacy protection, the model training system 120 can generate different datasets for users with different user data privacy settings. For example, based on user consent data, the system 120 can generate a first training dataset based on the user data for a first group of users having a first data privacy setting, and a second training dataset based on the user data for a second group of users having a second data privacy setting. The first data privacy setting can be different from the second group of users having a second data privacy setting in one or more ways. For example, the first group of users may have allowed their user data to be combined with data from other users with a certain privacy level, and allowed the combined data to be used for predicting insights for content distribution for a particular content platform (e.g., for the same content platform on which the user data is collected or for a different platform). The second group of users may have allowed their user data to be combined with data from other users, but required a different (e.g., higher) privacy level for how the data is combined and used. Based on the user consent data, the training data generation engine 124 can further exclude user data from certain users (e.g., users that have not given consent of using their data) from the training datasets.

The model training system 120 can generate a training dataset by aggregating user data profiles for each of a set of selected aggregation keys using the obtained user attribute data. For example, the system 120 can select an aggregation key based on contextual signals such as particular resource locators, particular digital components, particular geographic regions, and/or particular types of devices. An aggregation key can be in the form of <URL, Region, Device Type>. In another example, an aggregation key can be in the form of <Digital component identifier, Region, Device Type>. Other appropriate signals can also be used. Aggregation keys can include a combination of contextual signals, topics, and/or other appropriate signals. In a particular example, an aggregation key can be <example.com/flowers, Canada, smartphone>. The aggregated profile for this key would include data related to a subset of users that have visited example.com/flowers from smartphones located in Canada.

The system 120 can select the aggregation key from a list of candidate aggregation keys. The list of candidate aggregation keys can be configured by various entities, such as the digital component distribution system 150 and/or a content platform 140. The digital component distribution system 150 and/or a content platform 140 can provide, to the system 120, configuration data that defines the list of candidate aggregation keys. The configuration data can also define, for each candidate aggregation key, the types of data to include in an aggregated profile for the aggregation key. For example, the configuration data can specify that the aggregated profile for a candidate aggregation key is to include, for each of multiple user attributes, a count of the number of users or a percentage of the users for which data is aggregated for the aggregation key that have that user attribute. Many combinations of data types can be included in an aggregated profile.

Once an aggregation key has been selected, the system 120 can identify the subset of client devices from which the accumulated user attributes will be used to generate the aggregated profile for the selected aggregation key. For example, the subset of client devices can be the client devices that have accessed the electronic resource or the digital component identified by the aggregation key. The selection of the subset of client devices can further be based on user permission settings. As noted above, for each client device, a user may be provided with controls (e.g., user interface elements with which a user can interact) allowing the user to make an election as to both if and when systems, programs, or features may enable the collection of user information and how such information is used.

In some implementations, before and/or during generating the aggregated profile using the accumulated user attribute data from the subset of client devices, the system 120 can apply privacy-preserving techniques to the accumulated user attribute data. These techniques can include anonymizing the data for each user, e.g., by removing any user identifiers from the data, applying k-anonymity techniques, and/or applying differential privacy techniques to the aggregated data.

For each selected aggregation key, the system 120 generates the aggregated profile by aggregating the accumulated user attribute data obtained from the identified subset of client devices. As noted above, an aggregated profile for an aggregation key can include various types of aggregated user data about users for which data is aggregated for the aggregation key. For example, the aggregated profile for an aggregation key can include a count of the number of users or a percentage of the users of the subset of client devices that have a particular attribute. In a particular example, the aggregated profile for the aggregation key <example.com/flowers, Canada, smartphone> can specify a percentage of the users of the identified subset of client devices that are female, a percentage of the users that have interests in the topic of gardening, and/or a percentage of the users that are English speakers.

At 224, the model training system 120 uses the first training dataset and the second training dataset to train a machine learning model configured to predict information about one or more users. When the second group of users require a higher level of privacy level for their user data, the system 120 can apply differential privacy techniques when using the second training dataset to perform training of the machine learning model. For example, to apply the differential privacy process, the system 120 can apply a differentially private stochastic gradient descent (DP-SGD) algorithm with a certain privacy tradeoff parameter value to update model parameters of the machine learning model using the second training dataset.

At 226a, the system 120 sends data specifying the trained model to the digital component distribution system 150. The system 120 can further send data specifying the trained model to a content platform 1140 (at 226b).

At 252, the digital component distribution system 150 can select digital components based on user request using the prediction generated by the trained machine learning model. At 254, the digital component distribution system can distribute the selected digital components to client devices 110. For example, the machine learning model can be configured to process an input specifying one or more contextual signals included in a digital component request from a client device to generate prediction data about the user of the client device. The system 150 can use the prediction data about the user to determine which digital components are to be distributed to the client device of the user for display. In another example, the machine learning model can be configured to process an input characterizing a digital component to generate prediction data about an audience segment for the digital component. The system 150 can use the prediction data about the audience segment to determine which users to whom a particular digital component should be distributed to.

Similarly, at 246, the content platform 140 can distribute digital content and/or digital components to client devices 110 based on user request using the prediction generated by the trained machine learning model.

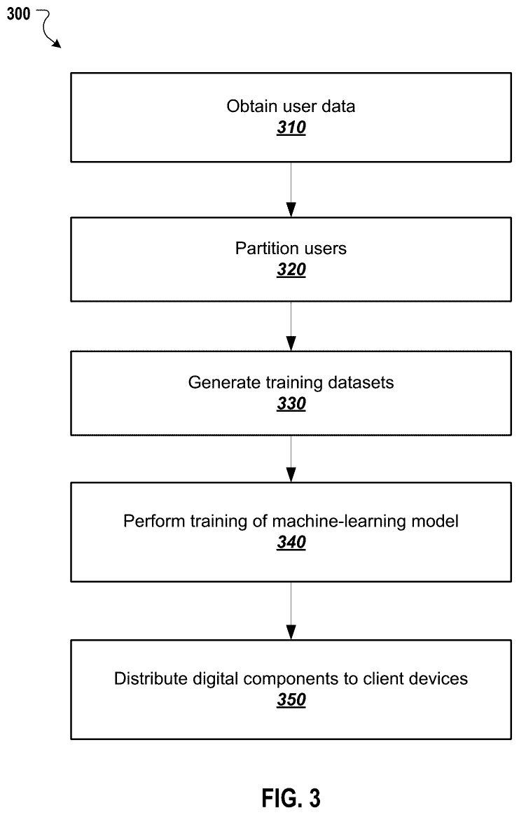

FIG. 3 is a flow diagram of an example process 300 for distributing digital components for display at client devices. Operations of the process 300 can be performed by a system of one or more computers located in one or more locations, such as a server, e.g., the digital component distribution system 150 and/or the model training system 120 described with reference to FIG. 1, appropriately programmed in accordance with this specification, can perform the process 300. Operations of the process 300 can also be implemented as instructions stored on one or more computer-readable media, which may be non-transitory, and execution of the instructions by one or more data processing apparatus can cause the one or more data processing apparatus to perform the operations of the process 300. For convenience and without loss of generality, the process 300 will be described as being performed by a data processing apparatus, e.g., a computer system.

At 310, the system obtains, for each user in a set of users, user data including user attribute data. The user data further includes, for a subset of the users, consent data for controlling usage of the user attribute data. In some implementations, the subset can be a proper subset that includes at least one but less than all members of the set of users. In some other implementations, the subset of the users include all users in the set.

In one example, the user data include user attribute data generated on a first content platform and consent data controlling usage of the attribute data generated on the first content platform for one or more second content platforms.

At 320, the system partitions, based at least on the consent data for the subset of users, the set of users into a first group of users and a second group of users.

In some implementations, the user data further includes location data indicating a geographic region of the user. The system partitions the users into the first group and the second group further based on the geographic region of the user. For example, for a certain geographic region, the system can assign the user to the first group if consent data is available for the user and the consent data for the user indicates the user permitting the one or more uses of the set of user data. If consent data is unavailable for the user or the consent data for the user does not indicate the user permitting the one or more uses of the set of user data, the system can assign the user to the second group.

At 330, the system generates a first training dataset based on the user data for the first group of users, and generates a second training dataset based on the user data for the second group of users. For example, to generate the first training dataset, for each of a set of aggregation keys, the system can generate an aggregated data profile by aggregating the user data of a respective subset of the first group of users having electronic resource views that match the aggregation key. To generate the second training dataset, for each of the set of aggregation keys, the system can generate an aggregated data profile by aggregating the user data of a respective subset of the second group of users having electronic resource views that match the aggregation key.

At 340, the system uses the first training dataset and the second training dataset to train a machine learning model configured to predict information about one or more users. In particular, the training includes applying differential privacy to the second training dataset without applying differential privacy to the first training dataset. For example, to apply the differential privacy to the second training dataset, the system can apply differentially private stochastic gradient descent (DP-SGD), e.g., with a predefined privacy tradeoff parameter value, to update model parameters of the machine learning model using the second training dataset. On the other hand, the system can use regular gradient descent or stochastic gradient descent to update the model parameters using the first training dataset.

In some implementations, the machine learning model is configured to process an input specifying one or more contextual signals included in a digital component request from a client device to generate prediction data about the user of the client device.

In some other implementations, the machine learning model is configured to process an input characterizing a digital component to generate prediction data about an audience segment for the digital component and/or user attributes of the user.

At 350, the system distributes digital components to client devices using the machine learning model. For example, the system can select one or more digital components for the user based on the predicted data output by the machine learning model. In a particular example, the system can select digital components that include, as distribution criteria, data indicating that the digital component is eligible for display to the predicted user audience and/or to users having the predicted attributes.

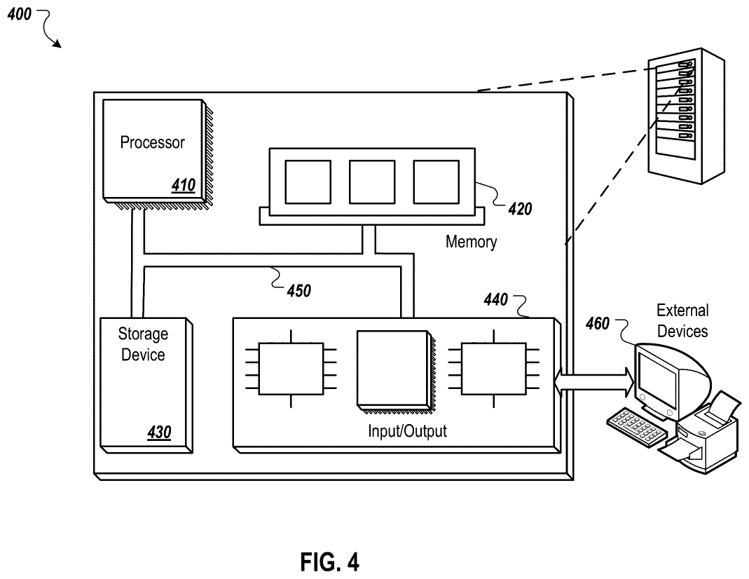

FIG. 4 is a block diagram of an example computer system 400 that can be used to perform the operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large-capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., an 802.11 card. In another implementation, the input/output device can include driver devices configured to receive input data and send output data to external devices 460, e.g., keyboard, printer, and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining, for each user in a set of users, user data comprising user attribute data and, for a subset of the users, consent data for controlling usage of the user attribute data for the users in the subset of the users;
partitioning, based at least on the consent data for the subset of users, the set of users into a first group of users and a second group of users;
generating a first training dataset based on the user data for the first group of users;
generating a second training dataset based on the user data for the second group of users;
training, using the first training dataset and the second training dataset, a machine learning model configured to predict information about one or more users, the training comprising applying differential privacy to the second training dataset without applying differential privacy to the first training dataset; and
distributing, digital components to client devices using the machine learning model.

2. The computer-implemented method of claim 1, wherein the machine learning model is configured to (i) process an input comprising data specifying one or more contextual signals included in a digital component request from a client device and to (ii) generate prediction data about the user of the client device based on the input.

3. The computer-implemented method of claim 1, wherein the machine learning model is configured to (i) process an input comprising data characterizing a digital component to (ii) generate prediction data about an audience segment for the digital component based on the input.

4. The computer-implemented method of claim 1, wherein the user data comprises (i) first user attribute data generated on a first content platform and (ii) first consent data controlling usage of the first user attribute data on one or more second content platforms.

5. The computer-implemented method of claim 1, wherein training the machine learning model on the second training dataset with differential-privacy processing comprises:
applying differentially private stochastic gradient descent (DP-SGD) to update model parameters of the machine learning model using the second training dataset.

6. The computer-implemented method of claim 1, wherein:
the user data for each user of the set of users comprises location data indicating a geographic region of the user; and
partitioning the set of users into the first group and the second group is further based on the geographic region of the user.

7. The computer-implemented method of claim 6, wherein partitioning the set of users into the first group and the second group comprises:
determining, based on the location data, that a user is located in a first geographic region; and
in response to determining that the user is located in the first geographic region, assigning the user to the first group if consent data is available for the user and the consent data for the user indicates the user permitting the one or more uses of the set of user data, and assigning the user to the second group if consent data is unavailable for the user or the consent data for the user does not indicate the user permitting the one or more uses of the set of user data.

8. The computer-implemented method of claim 6, wherein partitioning the set of users into the first group and the second group comprises:
determining, based on the location data, that a user is located in a second geographic region; and
in response to determining that the user is located in the second geographic region, assigning the user to the first group.

9. The computer-implemented method of claim 6, wherein partitioning the set of users into the first group and the second group comprises:
determining, based on the location data, that a user is located in a third geographic region; and
in response to determining that the user is located in the third geographic region, assigning the user to the second group.

10. The computer-implemented method of claim 6, wherein partitioning the set of users into the first group and the second group comprises, for each user:
determining, based on the location data, that a user is located in a fourth geographic region; and
in response to determining that the user is located in the fourth geographic region, excluding the user from both the first and the second group.

11. The computer-implemented method of claim 1, wherein the trained machine learning model is configured to output, based on the contextual signals in the digital component request, predicted data about the user of the digital component request.

12. The computer-implemented method of claim 1, wherein:
generating the first training dataset comprises, for each of a set of aggregation keys, generating an aggregated data profile by aggregating the user data of a respective subset of the first group of users having electronic resource views that match the aggregation key; and
generating the second training dataset comprises, for each of the set of aggregation keys, generating an aggregated data profile by aggregating the user data of a respective subset of the second group of users having electronic resource views that match the aggregation key.

13. The computer-implemented method of claim 12, generating the second training dataset further comprises, for each of the set of aggregation keys, before aggregating the user data of the respective subset of the second group of users, applying differential privacy to the user data of the respective subset of the second group of users.

14. The computer-implemented method of claim 12, wherein training the machine learning model comprises adding the aggregated data profiles as training labels of the machine learning model.

15. The computer-implemented method of claim 1, wherein the trained machine learning model is configured to output, based on the data characterizing the digital component, predicted data about one or more audience segments for the digital component.

16. The computer-implemented method of claim 1, wherein the respective set of user data comprises user profile data for a user registered on a digital service platform.

17. A system comprising:
one or more computers; and
one or more storage devices storing instructions that when executed by the one or more computers, cause the one or more computers to perform operations comprising:
obtaining, for each user in a set of users, user data comprising user attribute data and, for a subset of the users, consent data for controlling usage of the user attribute data for the users in the subset of the users;
partitioning, based at least on the consent data for the subset of users, the set of users into a first group of users and a second group of users;
generating a first training dataset based on the user data for the first group of users;
generating a second training dataset based on the user data for the second group of users;
training, using the first training dataset and the second training dataset, a machine learning model configured to predict information about one or more users, the training comprising applying differential privacy to the second training dataset without applying differential privacy to the first training dataset; and
distributing, digital components to client devices using the machine learning model.

18. One or more computer-readable storage media storing instructions that, when executed by one or more computers, cause the one or more computers to perform operations comprising:
obtaining, for each user in a set of users, user data comprising user attribute data and, for a subset of the users, consent data for controlling usage of the user attribute data for the users in the subset of the users;
partitioning, based at least on the consent data for the subset of users, the set of users into a first group of users and a second group of users;
generating a first training dataset based on the user data for the first group of users;
generating a second training dataset based on the user data for the second group of users;
training, using the first training dataset and the second training dataset, a machine learning model configured to predict information about one or more users, the training comprising applying differential privacy to the second training dataset without applying differential privacy to the first training dataset; and
distributing, digital components to client devices using the machine learning model.

19. The system of claim 17, wherein training the machine learning model on the second training dataset with differential-privacy processing comprises:
applying differentially private stochastic gradient descent (DP-SGD) to update model parameters of the machine learning model using the second training dataset.

20. The one or more computer-readable storage media of claim 18, wherein the user data for each user of the set of users comprises location data indicating a geographic region of the user; and
partitioning the set of users into the first group and the second group is further based on the geographic region of the user.
